(19) United States
(12) Patent Application Publication
(10) Pub. No.: US 2013/0264966 A1
(43) Pub. Date: Oct. 10, 2013

(54) LIGHT-EMITTING DISPLAY STICK

(71) Applicant: Manabu Hazawa, Tokyo (JP)

(72) Inventor: Manabu Hazawa, Tokyo (JP)

(73) Assignee: EXPLORE CORPORATION LIMITED, Tokyo (JP)

(21) Appl. No.: 13/992,746

(22) PCT Filed: Nov. 30, 2011
(86) PCT No.: PCT/JP2011/077657

§ 371 Date: Jun. 27, 2013

(30) Foreign Application Priority Data
Dec. 10, 2010 (JP) 2010-275837

(51) Int. Cl. H05B 37/02

(52) U.S. Cl. CPC H05B 37/0227
USPC 315/297

(57) ABSTRACT

There have been a variety of attempts to make light-emitting display sticks, used when directing traffic at night, cheering at various events, and the like, that not only simply emit light but take advantage of persistence of vision to display letters or patterns in space. However, depending on the manner in which and speed at which the stick is waved, said letters or patterns become distorted and unrecognizable. In light of this problem, the issue is to implement a light-emitting display stick that both is suited to cheering at events and can display easily recognizable letters in space regardless of the manner in which and speed at which the stick is waved. The light-emitting display stick in the present invention contains an internal waving-angle sensor and can display undistorted letters or patterns in space by having light-emitting elements emit light in accordance with waving-angle information indicating angles with respect to a base angle. Said light-emitting display stick can also switch to a mode in which all of the light-emitting elements emit light. Said light-emitting display stick is thus easier to use and more effective.

### TECHNICAL FIELD

The present invention relates to a display apparatus using light-emitting elements such as light-emitting diodes (hereinafter also referred to as “LED(s)”).

### BACKGROUND ART

Usually, when controlling the traffic for a road work or on a road where an accident has occurred, a stick is used for directing vehicles to stop or go ahead. For the stick, a hollow plastic one with miniature bulbs or light-emitting diodes incorporated in its inside is used with the miniature bulbs or the light-emitting diodes lighted for ensuring that the stick is visually recognized at night. However, the direction for stop or go-ahead is given by changing a manner of waving or holding the stick, resulting in the problem of difficulty in understanding or recognizing the direction because the manner somewhat differs among the individual persons who handle the sticks.

Also, in recent years, in events such as indoor concerts and various types of outdoor gatherings, many light-emitting sticks are waved for cheering. For the light-emitting sticks, small-size sticks each obtained by a substance that emits light by means of a chemical reaction being housed in a resin stick are often used, which, however, causes the problem of environmental pollution when such sticks are disposed of after use. In addition, there are also the problems that the light emission by means of a chemical reaction lasts for only a short period of time and such sticks are difficult to reuse. Furthermore, merely waving sticks that simply emit light lacks fun for boosting the cheering in an event.

In order to solve the aforementioned problems, various techniques have been disclosed.

In Patent Literature 1, a plurality of red and green light-emitting diodes (LEDs) are arranged in a straight line in a stick and lighted in red or green. Consequently, directions become easy to understand by difference in color: lighting in red for stop and lighting in green for go-ahead. However, directions depending on difference in color are not universally determined, and no disclosure of a technique of active display of a direction for stop/go-ahead of a vehicle is provided. Also, no regard is given to fun in lighting display when used for cheering in an event.

Patent Literature 2 discloses a technique of a message display toy that displays letters or a picture using a persistence of vision effect. In the technique, light-emitting diodes (LEDs) are aligned along a rod-like stick body and the LEDs are made to blink according to any of a plurality of blinking patterns for blinking the LED group and the stick is waved from side to side, whereby a picture or a literal text is displayed by a persistence of vision effect. If such display can be provided well, the display will exert an effect in traffic control or an event.

However, since timings for the blinking are determined by an internal timer circuit, it is difficult to make the reciprocation time and the waving speed in the side-to-side waving of the stick constant, and depending on the manner of waving, some of displayed letters drop out or displayed letters are reversed, or shrunk or expanded, which makes the letters unrecognizable.

As with Patent Literature 2, Patent Literature 3 discloses a technique of making LEDs aligned in a longitudinal direction of a stick blink according to letter display data read from a memory in a microcontroller chip and waving the stick to display letters by means of a persistence of vision effect. However, no clear technique is disclosed for timings for blinking, and when guessed from illustration of a clock generation circuit in a block diagram, as with Patent Literature 2, it is very difficult to provide constant speed and timings in waving the stick, and depending on the manner of waving, the displayed letters are interrupted or reversed, which makes the letters unrecognizable.

Patent Literature 4 discloses a technique that is the same as above in making LEDs aligned in a longitudinal direction of a stick blink according to letter display data read from a memory in a microcomputer and waving the stick to display letters by means of a persistence of vision effect, but includes a moving direction sensor and an acceleration sensor for timing start point determination and timing length determination for controlling a timing schedule in order to prevent the aforementioned problems in letter display. Such technique enables prevention of reversed letters, but some of displayed letters may drop out unless a speed for waving the stick is maintained constant because the speed is determined by the acceleration sensor. Furthermore, when the stick is being waved, if the speed for the waving is changed in the middle, the letters may be extended or shrunk or distorted in a middle part thereof, which makes the letters difficult to read.

### CITATION LIST

### Patent Literature

### Patent Literature 1: Japanese Utility Model Laid-Open No. 8-432

### Patent Literature 2: Japanese Patent Laid-Open No. 2005-230397

### Patent Literature 3: Japanese Patent Laid-Open No. 2005-62779

### Patent Literature 4: Japanese Patent Laid-Open No. 6-60295

### Non Patent Literature

Non Patent Literature 1: http://www.watty.co.jp/products/sensor/ha-101.html

### SUMMARY OF INVENTION

### Technical Problem

As described above, the sticks with a plurality of light-emitting elements incorporated therein have widely been used, but have the problem of providing display that is more recognizable as well as eye-catching for use in, e.g., an event. Furthermore, although there are techniques that provide letter display by means of a persistence of vision effect for easier visual recognition, such techniques have the problem that a manner of waving the stick for providing easy-to-see display is very difficult.

### Solution to Problem

A light-emitting display stick according to the present invention for solving the respective problems, an angle sensor and a reference angle setting switch are provided in a stick with a plurality of light-emitting elements provided in a longitudinal direction thereof, and lighting data is read from a memory by certain angle changes to light the respective LEDs.

Also, a mode in which the stick is waved from side to side to display letters by means of a persistence of vision effect, and a full-lighting mode in which all of the LEDs are consistently or intermittently lighted may be switched from one to the other.

Furthermore, a selection switch is provided to select letters to be displayed or a type of a pattern to be displayed in the letter display mode and to select a lighting color and a type of blinking in the full-lighting mode.

Also, the light-emitting elements may be provided on each of both front and back sides of a substrate so that the light-emitting elements on one side are lighted in the letter display mode and the light-emitting elements on the other side operate in the full-lighting mode, or both sides operate in the letter display mode or both sides operate in the full-lighting mode.

Furthermore, a connector is provided in the stick to connect the stick to an external personal computer or a mobile phone so that data in the memory can be rewritten.

### Advantageous Effects of Invention

As described above, conventionally, light-emitting sticks with a luminescent material or light-emitting elements encapsulated therein have been used for traffic control or cheering in events so that the sticks can be visually recognized even at night. For example, taking traffic control as an example, signs for stop/go-ahead for vehicles are given by the manner of holding or waving a light-emitting stick; however, use of a light-emitting display stick according to the present invention enables, in addition to light emission, waving the stick in the letter display mode to display letters “TOMARE (STOP)” or “SUSUME (GO AHEAD)”, provision of a specific direction, which can clearly be recognized from the vehicle side, enabling further enhancement of safety in traffic control. Furthermore, use of multicolor LEDs enables further enhancement of visual recognition if, for example, “TOMARE (STOP)” is displayed in red and “SUSUME (GO AHEAD)” is displayed in green.

Meanwhile, in display sticks such as those described in Patent Literatures 2 and 3, some of displayed letters may drop out or displayed letters may be reversed. Also, in Patent Literature 4, some of letters may drop out or the letters are expanded or shrunk in the middle unless a speed of waving the stick is maintained constant, resulting in difficulty in visual recognition; however, a letter display stick according to the present invention provides the effect of correctly displaying the entire letters irrespective of the speed by merely swing the stick by a certain angle or more.

Also, taking cheering or the like in an event for an example, use of a light-emitting display stick according to the present invention enables the stick to be waved in the full-lighting mode in which the entire stick is made to emit light, which has conventionally been done, and also enables a new type of cheering in which the color of emitted light is changed according to the content of the event. Furthermore, the mode is changed to the letter display mode so that a comment such as “SUTEKI! (GORGEOUS!)” or “GANBARE (GO FOR IT)” can be displayed for cheering, enabling further enhancement of communication between players and an audience. Furthermore, as in the case of traffic control, a new effect can be provided if the color of emitted light is changed depending on the literal comment.

In an example in which a light-emitting display stick according to the present invention is used for cheering, a user can rewrite letters to be displayed, via a personal computer or a mobile phone, and thus letters that can be considered most suitable for the scene in which the stick is used can be displayed and the color of emitted light and/or the light emission sequence can be changed, providing the effect of, even if a plurality of persons use the same light-emitting display sticks according to the present invention, allowing the persons to do cheering in different manners.

In addition to the aforementioned effects, as an application of a letter display stick according to the present invention, light-emitting elements are arranged on each of two sides of a long substrate to light the light-emitting elements on one side in the letter display mode and light the light-emitting elements on the other side in the full-lighting mode, providing the simultaneous effect of, for example, in an event site, encouraging players using letter display and bringing excitement to an audience in the site using full lighting. It should be understood that a new effect can be expected if the letter display mode or the full-lighting mode is selected for both of the two sides.

### BRIEF DESCRIPTION OF DRAWINGS

FIG. 1 is a schematic diagram of an embodiment of a light-emitting display stick according to the present invention.

FIG. 2 is a block diagram of an embodiment of a light-emitting display stick according to the present invention.

FIG. 3 is an illustrative diagram of a letter data storage state in an embodiment of a light-emitting display stick according to the present invention.

FIG. 4 illustrates a letter display state in an embodiment of a light-emitting display stick according to the present invention.

FIG. 5 is an illustrative diagram of a manner of providing letter display by means of a light-emitting display stick according to the present invention.

### DESCRIPTION OF EMBODIMENT

An embodiment of the present invention will be described with reference to the drawings. A scope necessary for description for achieving objects of the present invention is schematically indicated below and a scope necessary for description of a part of the present invention falling within that scope is mainly described, and parts of the present invention for which a description is omitted are ones according to known techniques.

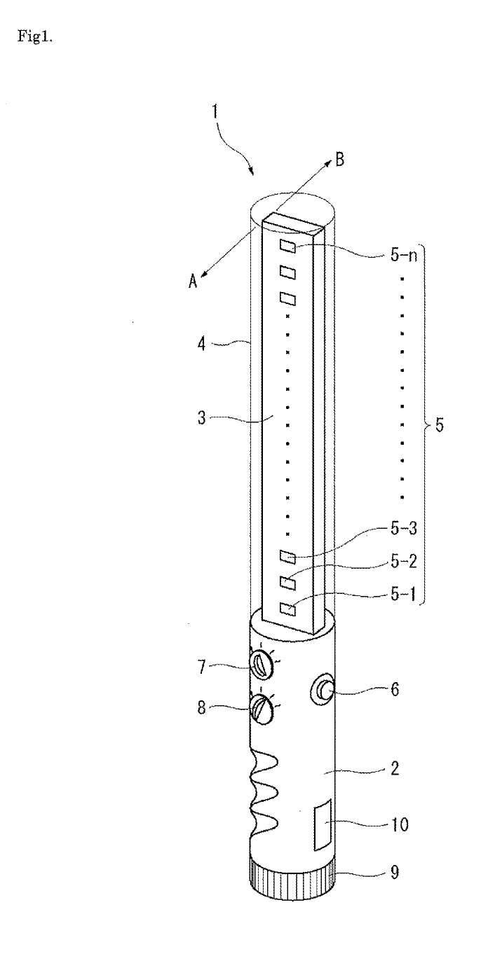

FIG. 1 is a diagram of an outer appearance of a light-emitting display stick 1 according to an embodiment of the present invention. The letter display stick 1 includes a substrate 3 joined to a grip 2 and a cover 4 also joined to the grip 2, the cover 4 covering the substrate 3. On a front side A of the substrate 3, a plurality of light-emitting elements 5 including light-emitting diodes or lamps 5-1, 5-2, 5-3, . . . , 5-n are mounted in a longitudinal direction. The cover 4 is made of a material that transmits light emitted by the light-emitting elements.

In the grip 2 in FIG. 1, a battery 26 (not illustrated) is housed and fixed by a battery housing cap 9. Also, at a side surface of the grip 2, a start button 6 for setting an angle at which letter display is started, a mode change switch 7 via which the power is turned on/off and a letter display mode and a full-lighting mode are switched from one to the other, a selection switch 8 via which the type of letters to be displayed is selected and a color of light emitted in the case of full lighting is selected, and an interface connector 10 (with a connector cover fitted therein in FIG. 1) for connection with a personal computer or a mobile phone.

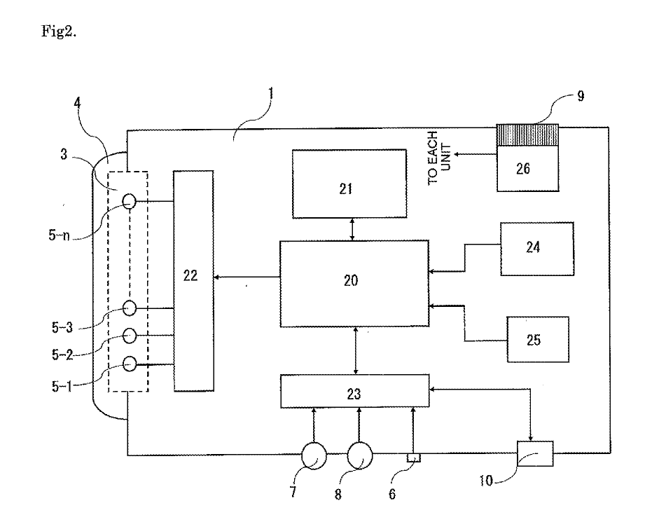

FIG. 2 is a block diagram of the light-emitting display stick 1 according to an embodiment of the present invention. A microcomputer (abbreviated as “pCPU”) 20 that is driven by a clock generation unit 25 reads display data at a relevant address in a memory unit 21 according to angle information from an angle sensor 24 and light corresponding display elements LED-1, LED-2, . . . , LED-n mounted on the substrate 3 via a display element lighting driver according to the display data. In the memory unit 21, a plurality of display letter data and display color data, and display color data and blinking pattern data for full display element lighting are stored.

Also, the μCPU 20 is connected to the power-on/off and mode change switch 7, the selection switch 8, the start button 6 and the interface connector 10 via an interface unit 23 for power-on/off, switching between the letter display mode and the full-lighting mode, an instruction for starting letter display, data exchange with a personal computer or a mobile phone. Furthermore, power from the battery 26 is supplied to the respective units described above.

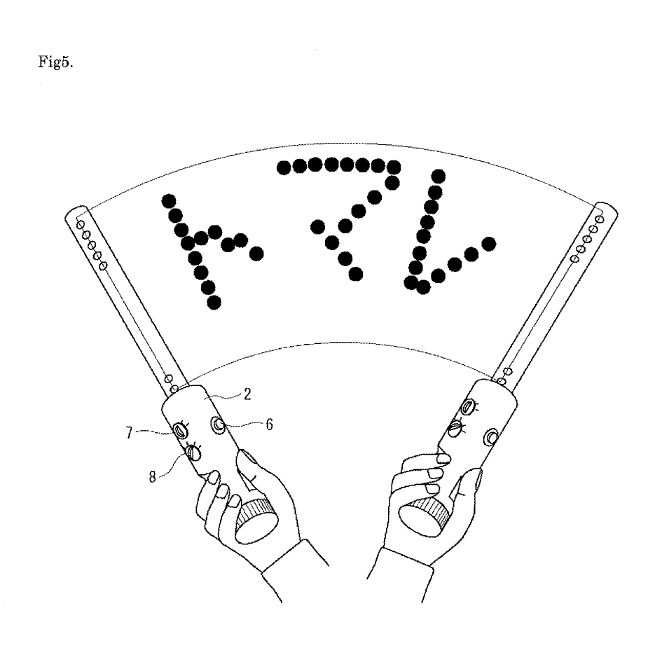

A description will be provided below on the respective units in the block diagram in FIG. 2. Each of the display elements 5-1, 5-2, . . . , 5-n can include a small bulb or a light-emitting diode, but desirably includes a surface-mount (SMD) light-emitting diode having high luminance and equipped with a three-color element. Also, for letter display state such as that in FIG. 5, which will be described later, an angle sensor that is based on a direction of gravitational force like one disclosed in Non Patent Literature 1 is preferable for the angle sensor 24. The respective units 21 to 26 and 6 to 9 are accommodated in the grip 2 described with reference to FIG. 1.

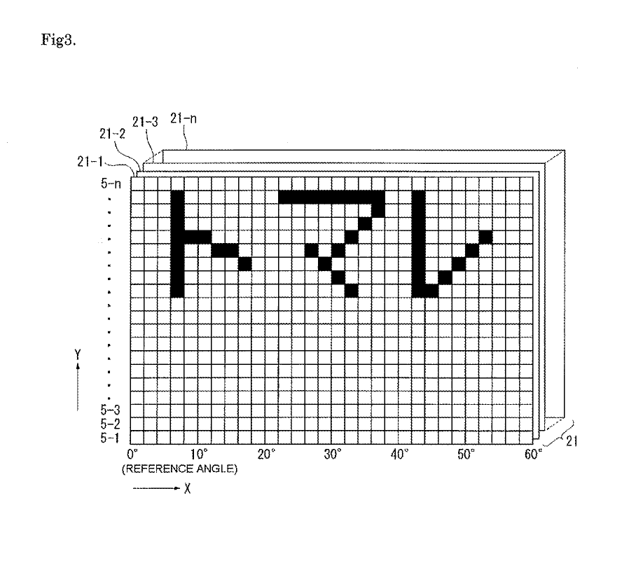

FIG. 3 is a diagram illustrating an example of a storage state of letter display data stored in the memory unit 21. In FIG. 3, a case where letters are displayed by swinging the light-emitting display stick 1 according to an embodiment of the present invention from 0 to 60 degrees is taken for an example. Address segmentation in the memory unit 21 is provided by, for example, angles on an X axis, 0 to 90 degrees by two-degree increments in FIG. 3, for example, and the light-emitting element 5-1, 5-2, . . . , 5-n on an Y axis. In other words, the μCPU 20 reads data for LED-1, LED-2, . . . , LED-n at a relevant position on the Y coordinate according to angle information from the angle sensor to, for example, light light-emitting elements corresponding to the filled part in FIG. 3. For the letter display data, arbitrary letter data can be written or rewritten via a keyboard of a personal computer or a mobile phone as a result of the light-emitting display stick 1 being connected to the personal computer or the mobile phone via the interface connector 10 in FIG. 2. While the above description has been provided in terms of whether or not the light-emitting elements are lighted according to data, it is obvious that the memory addresses may be multiplexed to include, for example, lighting data 21-1 and display color data 21-2, 21-3, . . . , 21-n.

For the letter display data, etc., arbitrary letter data and full-lighting data can be written or rewritten via a keyboard of a personal computer or a mobile phone connected the stick via the interface connector 10 in FIG. 2. Also, using the interface function, it is possible to provide an identifier to each light-emitting stick and perform the writing or rewriting by means of wireless, infrared or ultrasound remote control.

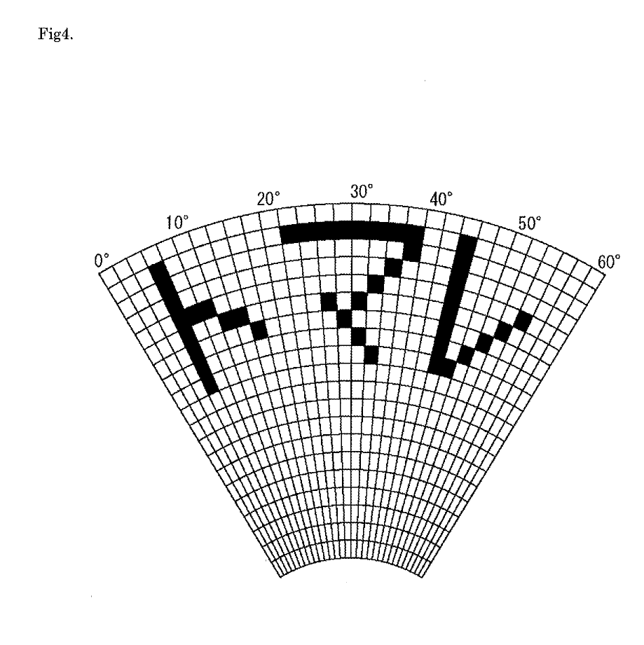

FIG. 4 is a diagram of example letter display where the light-emitting display stick 1 according to an embodiment of the present invention is swung in such a manner as described above. While FIG. 4 indicates an example in which letters are displayed so as to fill a display surface, it is obvious that the letter size can be reduced to display letters in two rows or a simple image can also be displayed.

FIG. 5 is an illustrative diagram for a case where letter display is provided using the light-emitting display stick 1 according to an embodiment of the present invention. First, the light-emitting display stick 1 is held at an angle at which letters are to be displayed (left end in the example in FIG. 5) and the display start button is pressed. As the light-emitting display stick 1 is swung to the right, corresponding light-emitting elements sequentially emit light, and a resulting image persists in the eyes, whereby letters are displayed in the air. Taking the description provided with reference to FIG. 3 for example, when the light-emitting display stick 1 has been swung to the right by 60 degrees, all the display letters are displayed (“TOMARE (STOP)” in the example in FIG. 5). Even if the light-emitting display stick 1 is swung to an angle exceeding 60 degrees, the light-emitting elements do not emit light because only data for up to 60 degrees are stored in the memory.

The light-emitting display stick 1 that has been swung by 60 degrees or more is then swung to the left from 60 degrees toward an initial setting angle of 0 degrees to display the letters in the air in the order opposite to the above from the right, i.e., “RE” in “TOMARE (STOP)” in the example in FIG. 5, and thus no reserved letters are displayed. As described above, a light-emitting display stick according to the present invention is used and swung by a set angle range or degrees exceeding such range, corresponding light-emitting elements emit light at each angle of the swing, and thus, even if a speed of the swing is not constant, the displayed letters are normally displayed in a manner that the letters can easily be visually recognized, without the displayed letters being shrunk or expanded.

Although FIG. 1 indicates an example of an light-emitting display stick according to an embodiment of the present invention with the light-emitting elements 5 mounted on only the side A of the substrate 3, light-emitting elements can be mounted on a side B so that the letter display mode is selected for the side A and the full-lighting mode is selected for the side B, or the display mode is selected for both sides A and B or the full-lighting mode is selected for both sides A and B.

As described above, a light-emitting display stick according to the present invention can be used as a traffic light stick for traffic control or a light-emitting stick for cheering in an event depending on the situation of the use, and furthermore, enables light emitting display that can easily be visually recognized and is suited to an environment of the use to be provided by switching between letter display and full-lighting modes. Furthermore, the light-emitting display stick which can be operated easily and provide letter display with less distortion can be used as communication assistance for a person with hearing disabilities.

### INDUSTRIAL APPLICABILITY

As described above, a light-emitting display stick according to the present invention can be used as a traffic light stick for traffic control or a light-emitting stick for cheering in an event depending on the situation of the use, and furthermore, enables light emitting display that can easily be visually recognized and is suited to an environment of the use to be provided by switching between letter display and full-lighting modes. Furthermore, the light-emitting display stick which can be operated easily and provide letter display with less distortion can be used as communication assistance for a person with hearing disabilities.

Also, a light-emitting display stick according to the present invention can also be used as an advertising media or a communication assistance tool for a person with speech disabilities in addition to use as a traffic light stick, a cheering tool or a toy, and thus brings high benefits to various industries.

### REFERENCE SIGNS LIST

1 . . . light-emitting display stick according to the present application, 2 . . . grip, 3 . . . substrate, 4 . . . cover, 5 (5-1, 5-2, . . . , 5-n) . . . light-emitting element, 6 . . . start button, 7 . . . mode change switch, 8 . . . selection switch, 9 . . . battery housing cap, 10 . . . interface connector, 20 . . . microcomputer (μCPU), 21 (21-1, 21-2, . . . , 21-n) . . . memory unit, 22 . . . lighting driver unit, 23 . . . interface unit, 24 . . . angle sensor unit, 25 . . . clock generation unit, 26 . . . battery

1. A light-emitting display stick including a plurality of light-emitting elements, the light-emitting display stick comprising:
a lighting drive unit for lighting the plurality of light-emitting elements;
a microcomputer that controls the lighting of each of the plurality of light-emitting elements; and
an angle sensor; and
a memory that stores lighting data for each of the plurality of light-emitting elements, the lighting data being drawn from the memory according to angle information from the angle sensor to light relevant light-emitting elements.

2. The light-emitting display stick according to claim 1, wherein a mode of display can be switched between a letter display mode in which the lighting data is drawn from the memory according to the angle information from the angle sensor to light the relevant light-emitting elements and a mode in which all of the plurality of light-emitting elements are lighted irrespective of an angle of the stick.

3. The light-emitting display stick according to claim 2, wherein in the letter display mode, a type of a letter or a pattern to be displayed can be selected, and in the full-lighting mode, a lighting color or a type of blinking can be selected.

4. The light-emitting display stick according to claim 1, wherein the light-emitting elements are provided on each of both front and back sides of a substrate and the plurality of light-emitting elements on both sides can be lighted simultaneously or in different modes.

5. The light-emitting display stick according to claim 1, wherein for each of the plurality of light-emitting elements, a light-emitting diode that emits different types of light as one element is used.

6. The light-emitting display stick according to claim 1, wherein memory data can be externally written or rewritten, and the light-emitting display stick further comprises an interface unit for writing and rewriting.

7. The light-emitting display stick according to claim 2, wherein the light-emitting elements are provided on each of both front and back sides of a substrate and the plurality of light-emitting elements on both sides can be lighted simultaneously or in different modes.

8. The light-emitting display stick according to claim 3, wherein the light-emitting elements are provided on each of both front and back sides of a substrate and the plurality of light-emitting elements on both sides can be lighted simultaneously or in different modes.

9. The light-emitting display stick according to claim 2, wherein for each of the plurality of light-emitting elements, a light-emitting diode that emits different types of light as one element is used.

10. The light-emitting display stick according to claim 3, wherein for each of the plurality of light-emitting elements, a light-emitting diode that emits different types of light as one element is used.

11. (canceled)

12. The light-emitting display stick according to claim 4, wherein for each of the plurality of light-emitting elements, a light-emitting diode that emits different types of light as one element is used.

13. The light-emitting display stick according to claim 7, wherein for each of the plurality of light-emitting elements, a light-emitting diode that emits different types of light as one element is used.

14. The light-emitting display stick according to claim 8, wherein for each of the plurality of light-emitting elements, a light-emitting diode that emits different types of light as one element is used.

15. The light-emitting display stick according to claim 2, wherein memory data can be externally written or rewritten, and the light-emitting display stick further comprises an interface unit for writing and rewriting.

16. The light-emitting display stick according to claim 3, wherein memory data can be externally written or rewritten, and the light-emitting display stick further comprises an interface unit for writing and rewriting.

17. The light-emitting display stick according to claim 4, wherein memory data can be externally written or rewritten, and the light-emitting display stick further comprises an interface unit for writing and rewriting.

18. The light-emitting display stick according to claim 7, wherein memory data can be externally written or rewritten, and the light-emitting display stick further comprises an interface unit for writing and rewriting.

19. The light-emitting display stick according to claim 8, wherein memory data can be externally written or rewritten, and the light-emitting display stick further comprises an interface unit for writing and rewriting.

20. The light-emitting display stick according to claim 5, wherein memory data can be externally written or rewritten, and the light-emitting display stick further comprises an interface unit for writing and rewriting.

21. The light-emitting display stick according to claim 9, wherein memory data can be externally written or rewritten, and the light-emitting display stick further comprises an interface unit for writing and rewriting.
